(19) United States
(12) Patent Application Publication
(10) Pub. No.: US 2012/0270139 A1
(43) Pub. Date: Oct. 25, 2012

(54) CATHODE MATERIAL FOR A FUEL CELL, CATHODE INCLUDING THE CATHODE MATERIAL, AND A SOLID OXIDE FUEL CELL INCLUDING THE CATHODE MATERIAL

(75) Inventors: Hee-jung PARK, Suwon-si (KR); Chan KWAK, Yongin-si (KR)

(73) Assignee: SAMSUNG ELECTRONICS CO., LTD., Suwon-si (KR)

(21) Appl. No.: 13/450,860

(22) Filed: Apr. 19, 2012

(30) Foreign Application Priority Data
Apr. 19, 2011 (KR) 10-2011-0036375
Oct. 13, 2011 (KR) 10-2011-0104835

(51) Int. Cl. H01M 4/86; H01M 4/64; H01M 8/10

(52) U.S. Cl. 429/485; 252/182.1

(57) ABSTRACT

A cathode material for a fuel cell, the cathode material including a first metal oxide having a perovskite crystal structure, and a second metal oxide including cerium and at least two lanthanide elements, the lanthanide elements having an average ionic radius of about 0.90 to about 1.02 Å.

### CROSS-REFERENCE TO RELATED APPLICATIONS

This application claims priority to Korean Patent Applications No. 10-2011-0036375, filed on Apr. 19, 2011, and No. 10-2011-0104835, filed on Oct. 13, 2011, and all the benefits accruing therefrom under 35 U.S.C. §119, the contents of which in their entirety are herein incorporated by reference.

### BACKGROUND

1. Field

The present disclosure relates to a cathode material for a fuel cell, a cathode including the cathode material, and a solid oxide fuel cell including the cathode materials.

2. Description of the Related Art

A solid oxide fuel cell (“SOFC”) is a highly efficient and eco-friendly electrochemical device that directly converts chemical energy of a fuel gas into electrical energy. In an SOFC the electrolyte is a solid oxide. The SOFC has many advantages over other types of fuel cells. For example, the fuel can be relatively inexpensive because the SOFC has a relatively high tolerance for fuel impurities, the SOFC can provide hybrid power generation capability, and the SOFC can provide high efficiency. Further, the SOFC can directly use a hydrocarbon based fuel without reforming the fuel into hydrogen, which simplifies the SOFC fuel cell system, reducing cost. The SOFC includes an anode where a fuel, such as hydrogen or a hydrocarbon, is oxidized, a cathode where oxygen gas is reduced to oxygen ions (O²⁻), and an ion conductive solid oxide electrolyte which is conductive to the oxygen ions (O²⁻).

Commercially available SOFCs operate at a high temperature, e.g. from about 800° C. to about 1000° C., require a long time for initial system start-up, and the operation time is limited by material durability. To accommodate the high operating temperature, commercially available SOFCs use an alloy that can withstand high temperatures or a ceramic material, both of which are expensive. Accordingly, the overall cost of the SOFC is a significant barrier to commercialization.

Therefore, many ongoing studies seek to lower the operational temperature of the SOFC to below 800° C. However, lowering the operational temperature of the SOFC causes a dramatic increase in the electrical resistance of the SOFC cathode material, and the resistance increase is a major factor contributing to decreased SOFC performance. As such, since the lowering of the operational temperature of the SOFC significantly affects the magnitude of the cathode resistance, it would be desirable to provide a cathode having less resistance when the SOFC is operated at a lower (e.g., intermediate) temperature.

### SUMMARY

Provided are is a cathode material for a fuel cell that provides a cathode having decreased polarization resistance.

Provided is a cathode for a fuel cell including the cathode material.

Provided is a solid oxide fuel cell including the cathode material.

Additional aspects will be set forth in part in the description which follows and, in part, will be apparent from the description.

According to an aspect, a cathode material for fuel cell includes a first metal oxide having a perovskite crystal structure; and a second metal oxide including cerium and at least two lanthanide elements, the lanthanide elements having an average ionic radius of about 0.90 to about 1.02 angstroms (Å).

The first oxide may be represented by Formula 1:

A₁₋ₓM¹O_{3±δ} Formula 1

wherein A is at least one element selected from a lanthanide element and an alkaline earth metal element, M¹ is at least one transition metal element, 0≦x≦0.2, and δ is selected so that the first metal oxide is neutral.

According to an embodiment, in Formula 1, A may be at least one element selected from La, Ba, Sr, Sm, Gd, and Ca, and M¹ may be at least one element selected from Mn, Fe, Co, Ni, Cu, Ti, Nb, Cr, and Sc.

According to an embodiment, the first metal oxide may be represented by Formula 2:

A′_{1-y-z}A″_{y-z′}M¹O_{3±δ} Formula 2

wherein A′ is at least one element selected from Ba, La, and Sm, A″ is at least one element selected from Sr, Ca, and Ba and is different from A′, M¹ is at least one element selected from Mn, Fe, Co, Ni, Cu, Ti, Nb, Cr, and Sc, 0≦y<1, 0≦z≦0.2, 0≦z′≦0.2 wherein 0≦y+z<1, y>z′, and 0≦z+z′≦0.2, and δ is selected so that the first metal oxide is electrically neutral.

The second metal oxide may have a fluorite crystal structure, and the average ionic radius of the lanthanide elements of the second metal oxide may be about 0.90 to about 1.02 Å, for example, about 0.96 to about 0.98 Å. According to an embodiment, the at least two lanthanide elements of the second metal oxide are selected from Sm, Pr, Nd, Pm, Eu, Gd, Tb, Dy, and an alloy thereof.

According to an embodiment, the second metal oxide is represented by Formula 3:

Ce_{1-a-b}SmₐM²_{b}O₂ Formula 3

wherein M² is at least one selected from Pr, Nd, Pm, Eu, Gd, Tb, Dy and an alloy thereof, 0<a≦0.20, 0<b≦0.20, and 0<a+b≦0.3.

In Formula 3, b may be a/2 or less.

A weight ratio of the first metal oxide to the second metal oxide may be about 1:9 to about 9:1, and more specifically, about 3:7 to about 7:3.

According to an embodiment, the cathode material for a fuel cell may further include a third metal oxide in addition to the first metal oxide and the second metal oxide.

According to an embodiment, the third metal oxide may be represented by Formula 4:

M₃³O₄ Formula 4

wherein M³ is at least one selected from Co, Fe, Mn, V, Ti, Cr, and an alloy thereof.

For example, the third metal oxide may include at least one selected from Co₃O₄, Fe₃O₄, and Mn₃O₄.

The melting point of the third metal oxide may range from about 800° C. to about 1800° C.

A weight ratio of the first metal oxide to the third metal oxide may be about 60:40 to about 99:1.

According to another embodiment, a cathode including the cathode material for a fuel cell is provided.

According to another embodiment, disclosed is a fuel cell including a cathode including the cathode material for a fuel cell disclosed above; an anode disposed opposite to the cathode; and a solid oxide electrolyte interposed between the cathode and the anode.

The fuel cell may further include a reaction preventing layer effective to prevent or suppress a reaction between the cathode and the solid oxide electrolyte.

The reaction preventing layer may include at least one selected from gadolinium doped ceria (“GDC”), samarium doped ceria (“SDC”), and yttrium doped ceria (“YDC”).

The fuel cell may further include a current collector layer disposed on a side of the cathode opposite the solid oxide electrolyte.

The current collector may be at least one selected from a lanthanum cobalt oxide (e.g., LaCoO₃), a lanthanum strontium cobalt oxide (“LSC”), a lanthanum strontium cobalt ferrite, a lanthanum strontium chrome manganese oxide (“LSCM”), a lanthanum strontium manganese oxide (“LSM”), and a lanthanum strontium ferrite (“LSF”).

Also disclosed is a method of manufacturing a cathode material, the method including: contacting a first metal oxide having a perovskite crystal structure, a second metal oxide including cerium and at least two lanthanide elements, and a solvent to form a slurry; and heating the slurry to form the cathode material.

In an embodiment, the method may further include disposing the slurry on a substrate; and the heating may include heating the slurry and the substrate to form a cathode.

### BRIEF DESCRIPTION OF THE DRAWINGS

These and/or other aspects will become apparent and more readily appreciated from the following description of the embodiments, taken in conjunction with the accompanying drawings in which:

FIG. 1 illustrates an AMO₃ crystal structure of a perovskite type compound;

FIG. 2 is a conceptual view of a triple phase boundary in a cathode;

FIG. 3 is a schematic cross sectional view of an embodiment of a solid oxide fuel cell;

FIG. 4 is a graph of log conductivity, σ (siemens per centimeter, S/cm) versus 1000/temperature, 1000/T (1/Kelvin, 1/K) and shows the ionic conductivity of an ion conductor of the formula Ce_{0.8}Sm_{0.15}Nd_{0.05}O₂ (“SNDC”) used for a cathode material in Preparation Examples 1-3 and that of Ce_{0.9}Gd_{0.1}O₂ (“GDC10”) of Comparative Example 1;

FIG. 5 is a cross sectional schematic view of symmetric cells of Examples 1-3, and Comparative Example 3;

FIG. 6 is a cross sectional schematic view of a symmetric cell of Comparative Example 2;

FIG. 7 is a graph of intensity (arbitrary units, a.u.) versus scattering angle (degrees two theta, 20) and shows X-ray diffraction patterns of the LSCF, L_{0.55}SCF, and SNDC cathode materials used for the symmetric cells of Examples 1-3, and Comparative Example 1;

FIG. 8 is a scanning electron micrograph (“SEM”) of a cross section of the symmetric cell manufactured in Example 3;

FIG. 9 is a SEM of a cross section of the symmetric cell manufactured in Comparative Example 2;

FIG. 10 is a graph of reactance (Z₂, ohms·cm²) versus resistance (Z₁, ohms·cm²) showing the results impedance measurements of the symmetric cells manufactured in Examples 1-3 and Comparative Examples 2 and 3;

FIG. 11 is a graph of log resistance, Rₚ (ohm·cm²) versus 1/temperature, 1/T (1/Kelvin, 1/K) which shows cathode resistivity with respect to operating temperature of the symmetric cells manufactured in Examples 1-3 and Comparative Example 2;

FIG. 12 is a graph of reactance (Z₂, ohms·cm²) versus resistance (Z₁, ohms·cm²) showing the results of impedance measurements of the symmetric cells manufactured in Example 4 and Comparative Example 4; and

FIG. 13 is a graph of log resistance, Rₚ (ohm·cm²) versus 1/temperature, 1/T (1/Kelvin, 1/K) and shows cathode resistivity with respect to operating temperature for the symmetric cells manufactured in Example 4 and Comparative Example 4.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items. “Or” means “and/or.”

It will be understood that, although the terms “first,” “second,” “third” etc. may be used herein to describe various elements, components, regions, layers and/or sections, these elements, components, regions, layers, and/or sections should not be limited by these terms. These terms are only used to distinguish one element, component, region, layer or section from another element, component, region, layer, or section. Thus, “a first element,” “component,” “region,” “layer,” or “section” discussed below could be termed a second element, component, region, layer, or section without departing from the teachings herein.

The terminology used herein is for the purpose of describing particular embodiments only and is not intended to be limiting. As used herein, the singular forms “a,” “an,” and “the” are intended to include the plural forms as well, unless the context clearly indicates otherwise. It will be further understood that the terms “comprises” and/or “comprising,” or “includes,” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Generally, electrochemical reactions of a solid oxide fuel cell (“SOFC”) include a cathode reaction where oxygen gas (O₂) from a gas electrode (i.e., a cathode) is transformed into oxygen ions O²⁻, and an anode reaction where a fuel (H₂ or a hydrocarbon) from a fuel electrode (i.e., an anode) reacts with the oxygen ions, which transport through an electrolyte, as expressed in Scheme 1:

Cathode: ½O₂+2e⁻→O²⁻

Anode: H₂+O²⁻→H₂O+2e⁻ Scheme 1

Maintaining an oxygen partial pressure difference by continuously injecting air into the gas electrode creates a driving force that moves the oxygen ions through the electrolyte. When these reactions occur in a fuel cell, electrons flow through the electrodes and may be collected at a current collector, which may be connected to an external wire.

According to an aspect, a cathode material for a fuel cell includes a perovskite type metal oxide, i.e., a first metal oxide having a perovskite crystal structure, and a dual-doped ceria based metal oxide, i.e., a second metal oxide which is doped and comprises cerium. While not wanting to be bound by theory, it is understood that the combination of the perovskite type metal oxide and the dual-doped ceria based metal oxide enlarges a triple phase boundary at which a cathode reaction may occur, thus decreasing a polarization resistance of a cathode.

The perovskite type metal oxide included in the cathode material for a fuel cell is a mixed ionic and electronic conductor (“MIEC”) which provides excellent electrode activity at low temperatures. The MIEC is a mixed conductor having both high electronic conductivity and high ionic conductivity in a single phase. While not wanting to be bound by theory, it is understood that the MIEC contributes to lowering an operating temperature of an SOFC because the MIEC material has excellent electrode activity at low temperatures since the material has a high oxygen diffusion coefficient and a high charge transfer coefficient, leading to an oxygen reduction reaction occurring not only at the triple phase boundary but also on other surfaces of an electrode, e.g., the entire surface of an electrode.

According to an embodiment, the perovskite type metal oxide, which is a MIEC, may be represented by Formula 1:

A₁₋ₓM¹O_{3±δ}, Formula 1
wherein A is at least one element selected from lanthanide elements and alkaline earth metal elements,
M¹ is at least one transition metal element,
0≦x≦0.2, and
δ represents an oxygen surplus or shortage amount.

According to an embodiment, in Formula 1, A is at least one element selected from lanthanum (La), barium (Ba), strontium (Sr), samarium (Sm), gadolinium (Gd), and calcium (Ca), and M¹ is at least one element selected from manganese (Mn), iron (Fe), cobalt (Co), nickel (Ni), copper (Cu), titanium (Ti), niobium (Nb), chromium (Cr), and scandium (Sc). The transition metal element is an element of Groups 3 to 12 of the Periodic Table of the Elements. Also δ may be selected so that the compound of Formula 1 is electrically neutral.

For example, the perovskite type metal oxide may be represented by Formula 2:

A′_{1-y-z}A″_{y-z′}M¹O_{3±δ} Formula 2
wherein A′ is at least one element selected from Ba, La, and Sm,
A″ is at least one element selected from Sr, Ca, and Ba and is different from A′,
M¹ is at least one element selected from Mn, Fe, Co, Ni, Cu, Ti, Nb, Cr, and Sc, 0≦y<1, 0≦z≦0.2, 0≦z′≦0.2 wherein 0≦y+z<1, y>z′, and 0≦z+z′≦0.2, and
δ represents the oxygen surplus or shortage amount.
   δ may be selected so that the compound of Formula 2 is electrically neutral.

As can be seen from Formula 1, the perovskite type metal oxide may or may not have a defect at a metal site. Generally, a perovskite has the general formula ABO₃ and a crystal structure as shown in FIG. 1, in which A sites are for a positive metal ion having a relatively large size and are centered on corners of a cube, a B site is for a positive metal ion having a relatively small size and is centered in the cube, and 0 sites are for negative ions and are centered in faces of the cube. Having a metal defect in the perovskite lattice structure helps to provide a hole, e.g., an open space, in the perovskite lattice structure, which can facilitate ion conduction (e.g., by a hopping mechanism), improving the ionic conductivity of the cathode material. A hole is more reliably provided when the defect is at an A site, rather than at a B site.

In Formula 1, x, which represents an amount of metal defects in the A sites, may be 0 if there are no defects at the A sites, and may be about 0<x≦0.2 if there are defects at A sites. For example, x may be about 0<x≦0.15, and more specifically, about 0<x≦0.1. In addition, δ, which is selected so that the perovskite type metal oxide is electrically neutral, represents the oxygen surplus or shortage amount and is, for example, about 0≦δ≦0.3, specifically about 0.05≦δ≦0.28, more specifically about 0.1≦δ≦0.26.

In Formula 2, y represents a mole fraction of A″ and the amount of metal defects is the sum of z and z′, wherein z represents the defects associated with A′ and z′ represents the defects associated with A″.

A′_{1-y-z}A″_{y-z′}M¹O_{3±δ} Formula 2

As noted above, in Formula 2, A′ is at least one element selected from Ba, La, and Sm, A″ is at least one element selected from Sr, Ca, and Ba and is different from A′, M¹ is at least one element selected from Mn, Fe, Co, Ni, Cu, Ti, Nb, Cr, and Sc, 0≦y<1, 0≦z≦0.2, 0≦z′≦0.2 wherein 0≦y+z<1, y>z′, and 0≦z+z′≦0.2, and δ represents the oxygen surplus or shortage amount. δ may be selected so that the compound of Formula 2 is electrically neutral.

The perovskite type metal oxide may be, for example, a lanthanum-ferrite based material. A lanthanum-ferrite based material may be desirable since a lanthanum-ferrite based material can have a low coefficient of thermal expansion, e.g., below 20 parts per million per Kelvin (ppm/K), and a high melting point, and thus can provide improved durability. For example, in Formula 1, A may be at least one element selected from Ba, Sr, Sm, Gd, and Ca, and M¹ is at least one element selected from Mn, Fe, Co, Ni, Cu, Ti, Nb, Cr, and Sc. An embodiment wherein A is Sr and M¹ is Fe is specifically mentioned. However, A′ and M¹ are not limited thereto.

The cathode material for a fuel cell comprises the perovskite type metal oxide and the co-doped ceria based metal oxide to provide increased ionic conductivity. The ceria based metal oxide can be a cubic material having a fluorite crystal structure, and is doped with at least two different lanthanide elements to stably provide high ionic conductivity even at a low temperature. The at least two different lanthanide elements may have an average ionic radius of about 0.90 to about 1.02 angstroms (Å), specifically 0.93 to 0.99 Å, more specifically about 0.96 to about 0.98 Å. The lanthanide elements doped in the ceria based metal oxide generally have a valance of +3.

Generally, doped ceria materials are known to have an ionic conductivity superior to that of a zirconia solid electrolyte, and thus may be used as a material for a high performance solid electrolyte. In addition, doped ceria materials can prevent a reaction between the cathode and an adjacent material. Among the doped ceria materials, samarium doped ceria (“SDC”, Sm-doped CeO₂) or gadolinium doped ceria (GDC, Gd-doped CeO₂), which is a singly doped ceria, is known to have relatively high ionic conductivity of commercially available doped ceria materials. As will be further described below, in an embodiment the ceria based metal oxide of the cathode material for a fuel cell is co-doped with at least two different lanthanide elements and has a higher ionic conductivity than the samarium doped ceria material, which has the highest ionic conductivity of commercially available singly-doped ceria metal oxides.

Co-dopants that are doped into Ce sites of the ceria based metal oxide, as the different lanthanide elements, may be at least two quadrivalent lanthanide metals. As an average ionic radius of the different lanthanide elements becomes closer to a range of about 0.90 to about 1.02 Å, the ionic conductivity of the ceria based metal oxide rises. For example, the average ionic radius may be about 0.96 to about 0.98 Å. Therefore, the ceria based metal oxide may be doped with at least two different elements selected from the lanthanide elements. In an embodiment, the at least two different elements selected from the lanthanide elements can be at least two different elements selected from samarium (Sm), praseodymium (Pr), neodymium (Nd), promethium (Pm), europium (Eu), gadolinium (Gd), terbium (Tb), dysprosium (Dy), and an alloy thereof. For example, the ceria based metal oxide may include Sm and an element selected from Pr, Nd, Pm, and an alloy thereof as a dopant, as expressed in Formula 3:

Ce_{1-a-b}SmₐM_{b}²O₂ Formula 3

wherein M² is at least one selected from Pr, Nd, Pm, Eu, Gd, Tb, Dy and an alloy thereof, 0<a≦0.20, 0<b≦0.20, and 0<a+b≦0.3.

An amount of M² to be doped together with Sm may not exceed 100% of an amount of Sm to be doped, because if the doping amount of M² exceeds the doping amount of Sm, the ionic conductivity of the ceria based metal oxide may decrease. For example, the doping amount of M² may be 50 mole % or less of the doping amount of Sm. In an embodiment, the amount of M² may be 1 to 45 mole %, more specifically 2 to 40 mole % of the amount of Sm. In other words, in Formula 3, b may be a/2 or less, specifically a/3 or less, more specifically a/4 or less.

In the cathode material, to provide improved ionic conductivity, a content of the perovskite type metal oxide and the ceria based metal oxide may be in a weight ratio of about 1:9 to 9:1. For example, the perovskite type metal oxide and the ceria based metal oxide may be in a weight ratio of about 3:7 to 7:3, for example, about 4:6 to 6:4.

According to an embodiment, the cathode material may further include a spinel type metal oxide (i.e., a third metal oxide) in addition to the perovskite type metal oxide (i.e., the first metal oxide) and the ceria based metal oxide (i.e., the second metal oxide). A spinel structure is a crystal structure seen in an oxide that is represented by the general formula XY₂O₄, and has ferrimagnetism. The spinel structure can be classified as a regular spinel structure, in which oxygen ions occupy sites in a face centered cubic structure, X²⁺ cations occupy tetrahedral sites and are surrounded by 4 oxygen ions, and Y³⁺ cations occupy octahedral sites and are surrounded by 6 oxygen ions. Alternatively, the spinel structure can be an inverse spinel structure in which Y³⁺ cations occupy tetrahedral sites and X²⁺ and Y³⁺ each occupy half of the octahedral sites. Either structure includes 8 XY₂O₄ in a unit lattice.

According to an embodiment, the spinel type metal oxide may be represented by Formula 4:

M₃³O₄, Formula 4

wherein M³ is at least one selected from Co, Fe, Mn, vanadium (V), Ti, Cr, and an alloy thereof.

In Formula 4, the spinel type metal oxide is a mixed valence compound having the regular spinel structure in which (M³)²⁺ ions occupy tetrahedral positions and (M³)³⁺ ions occupy octahedral positions. According to an embodiment, the spinel type metal oxide may comprise at least one selected from Co₃O₄, Fe₃O₄, and Mn₃O₄.

The spinel type metal oxide enables forming (e.g., coating) a cathode at a low temperature (e.g., less than 1000° C., specifically 500° C. to 900° C., more specifically 600° C. to 800° C.) to forming a SOFC cathode, thereby suppressing or effectively eliminating formation of a non-conductive layer that can cause performance deterioration and improving adhesion between an electrolyte and a cathode material.

On the other hand, in order to reduce the heat treatment temperature, a spinel type metal oxide having a low melting point may be used. For example, the melting point of the spinel type metal oxide may range from about 800° C. to about 1800° C. Specifically, the melting point of the spinel type metal oxide may range from about 900° C. to about 1500° C., more specifically 1000° C. to 1400° C. Considering a suitable heat treatment temperature in a process of manufacturing a cell, a spinel type metal oxide having a melting point less than 800° C. would not be appropriate. The melting point refers to a temperature at which a solid state and a liquid state of a material co-exist. In other words, the melting point is defined as a temperature at which the material melts under one atmosphere of pressure. The melting point may be measured from a phase change (a change from a solid state to a liquid state) or a thermal change while varying a temperature of the material under one atmosphere of pressure.

According to an embodiment, a weight ratio of the perovskite type metal oxide to the spinel type metal oxide may be about 60:40 to 99:1, specifically about 65:35 to 98:2, more specifically about 70:30 to 96:4.

When the cathode material disclosed herein is used in a cathode in a solid oxide fuel cell a cathode reaction occurs in which oxygen gas is reduced to oxygen ions at a triple phase boundary (“TPB”) formed by the perovskite type metal oxide, the ceria based metal oxide, and the oxygen gas.

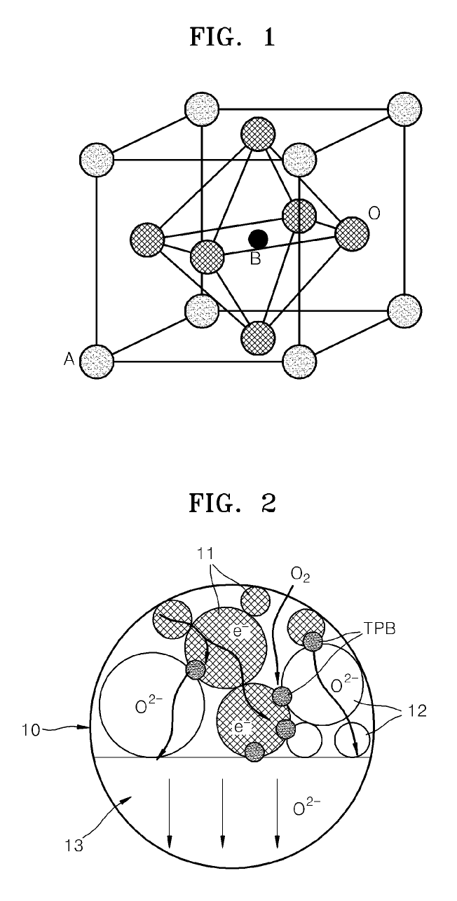

Referring to FIG. 2, and while not wanting to be bound by theory, at the TPB in a cathode, oxygen gas (O₂) supplied to the cathode combines with electrons which transport through the electron conductive perovskite type metal oxide 11 and is reduced to oxygen ions O²⁻. Then the oxygen ions O²⁻ transport through the ceria based metal oxide 12 to an electrolyte 13 or another functional layer interposed between the cathode and the electrolyte 13. Here, an area where the oxygen gas (O₂), the perovskite type metal oxide 11, and the ceria based metal oxide 12 contact each other is the TPB, which is where reduction of oxygen occurs. While not wanting to be bound by theory, it is understood that the perovskite type metal oxide serves as both an electron conductor and as an ion conductor due to the non-stoichiometry of the perovskite type metal oxide. Also, the co-doped ceria based metal oxide, which is used with the perovskite type metal oxide, has high ionic conductivity and may contribute to improving the ionic conductivity of the cathode material. The combination of the perovskite type metal oxide and the co-doped ceria based metal oxide provide an unexpected decrease in cathode resistance.

According to an aspect, a cathode for a fuel cell includes the foregoing cathode material. In particular, the cathode can be advantageously applied as a cathode for a solid oxide fuel cell.

The cathode material may be manufactured by contacting the perovskite type metal oxide (i.e. the first metal oxide), the ceria based metal oxide (i.e., the second metal oxide), and a solvent to form a slurry, and heating the slurry to form the cathode material. The cathode may be manufactured by preparing a slurry from a mixture of the perovskite type metal oxide (i.e. the first metal oxide), the ceria based metal oxide (i.e., the second metal oxide), and a solvent, disposing (e.g., coating) the slurry onto a substrate, and then heating the disposed slurry. The heating can remove the solvent to provide a layer comprising the perovskite type metal oxide the ceria based metal oxide.

The solvent may be any suitable organic liquid, and can comprise at least one solvent selected from an alcohol, a ketone, an aldehyde, and an ester.

Representative alcohols include at least one selected from primary and secondary alcohols, such as methanol, n-propanol, isopropanol, n-butanol, sec-butanol, isobutanol, pentanol, hexanol, 2-ethylhexanol, tridecanol, and stearyl alcohol; cyclic alcohols such as cyclohexanol, and cyclopheptanol; aromatic alcohols such as benzyl alcohol, and 2-phenyl ethanol; polyhydric alcohols such as ethylene glycol, propylene glycol, 1,3-butanediol, 1,4-butanediol, 1,5-pentanediol, hexamethylene glycol, decamethylene glycol, 1,12-dihydroxyoctadecane, and glycerol; polymeric polyhydric alcohols such as polyvinyl alcohol; glycol ethers such as methyl glycol, ethyl glycol, butyl glycol, diethylene glycol, triethylene glycol, tetraethylene glycol, dipropylene glycol, tripropylene glycol, polypropylene glycol ether, and polybutylene glycol ether; aminated alcohols such as ethanolamine, propanolamine, isopropanolamine, hexanolamine, diethanolamine, diisopropanolamine, and dimethylethanolamine; and aminated polyhydric alcohols and glycol ethers such as aminated polyethylene glycol.

Suitable ketones include aliphatic ketones; diketones; cyclic ketones; and aromatic ketones. Representative ketones include 2-propanone(acetone); 2-butanone(methyl ethyl ketone); 2-pentanone(methyl propyl ketone); 3-methyl-2-butanone(methyl isopropyl ketone); 4-methyl-2-pentanone(methyl isobutyl ketone); 2-hexanone(methyl n-butyl ketone); 3-methyl-2-pentanone(methyl sec-butyl ketone); 3,3-dimethyl-2-butanone(pinacolone); 2-heptanone(methyl amyl ketone); 5-methyl-2-hexanone(methyl isoamyl ketone); 2-octanone(methyl hexyl ketone); 4-hydroxy-4-methyl-2-pentanone(diacetone alcohol); 3-pentanone(diethyl ketone); 2,4-dimethyl-3-pentanone(diisopropyl ketone); 2,6-dimethyl-4-heptanone(diisobutyl ketone); 3-hexanone(ethyl propyl ketone); 3-heptanone(butyl ethyl ketone); 3-octanone(ethyl amyl ketone); 2,6,8-trimethyl-4-nonanone(isobutyl heptyl ketone); 3-buten-2-one(methyl vinyl ketone); 3-methyl-2-buten-2-one(methyl isopropenyl ketone); 4-methyl-3-penten-2-one(mesityl oxide); 4-methyl-4-penten-2-one(isomesityl oxide); 3,5,5-trimethyl-2-cyclohexen-1-one(isophorone); 3,5,5-trimethyl-3-cyclohexen-1-one; 2,3-butanedione(diacetyl); 2,3-pentanedione; 2,4-pentanedione(acetylacetone); 2,5-hexanedione; cyclopentanone(adipic ketone); cyclohexanone(pimelic ketone); cycloheptanone; 3,3,5-trimethylcyclohexanone; acetophenone(methyl phenyl ketone); benzophenone(diphenyl ketone); 1-phenyl-2-propanone(phenylacetone); propiophenone(phenyl ethyl ketone), 2,3-pentanedione; 2,3-hexanedione; 3,4-hexanedione; 4-methyl-2,3-pentanedione; 3,4-heptanedione; 2,4-hexanedione; 3,5-heptanedione; 2,4-heptanedione; 3,5-octanedione; cyclopropanone; cyclobutanone; acetophenone, propiophenone, and benzophenone.

Examples of suitable esters include formates, acetates, proprionates, pentanoates, crotonates, and benzoates. Specific examples of suitable esters include formate, benzoyl formate, chloroacetate, trifluoroacetate, methoxyacetate, triphenylmethoxyacetate, p-chlorophenoxyacetate, 3-phenylpropionate, 4-oxopentanoate, 4,4-(ethylenedithio)pentanoate, pivaloate(trimethylacetate), crotonate, 4-methoxy-crotonate, benzoate, p-benzyl benzoate, and 2,4,6-trimethylbenzoate.

Representative aldehydes include formaldehyde; acetaldehyde; propionaldehyde; butanal(n-butyraldehyde); 2-methylpropanal(isobutyraldehyde); pentanal(n-valeraldehyde); 3-methylbutanal(isovaleraldehyde); hexanal(caproaldehyde); benzaldehyde; heptanal(heptaldehyde); octanal(caprylaldehyde); phenylacetaldehyde; o-tolualdehyde; m-tolualdehyde; p-tolualdehyde; salicylaldehyde (o-hydroxybenzaldehyde); p-hydroxybenzaldehyde (4-formylphenol); and p-anisaldehyde (p-methoxybenzaldehyde).

In an embodiment, the solvent may comprise water.

The substrate on which the slurry is disposed may be an electrolyte, for example, an electrolyte on at least one side of which a functional layer is disposed. For example, the substrate may be a solid oxide electrolyte, for example, a solid oxide electrolyte on at least one side of which a functional layer is disposed. Here, the functional layer formed on at least one side of the electrolyte may be a reaction preventing layer which is effective to prevent or suppress the formation of a non-conducting layer between the electrolyte and the cathode by preventing or suppressing a reaction between the electrolyte and the cathode. The slurry may be coated on the electrolyte or on the functional layer therein, via various coating methods, such as a coating method selected from, but not limited to, screen printing, dip coating, and spray coating.

Heating the slurry coated on the substrate at a temperature of about 800° C. or higher forms a cathode layer. For example, the heating temperature may be about 800° C. to about 1200° C., specifically about 900° C. to about 1100° C. A hybrid cathode layer manufactured in this temperature range may decrease a polarization resistance of the cathode without any substantial undesirable change in the electrical properties or structures of the perovskite type metal oxide and the ceria based metal oxide contained in the cathode material. Therefore, the cathode manufactured at such a heating temperature may serve as a stable hybrid conductor when used in a SOFC that operates at a reduced temperature (e.g., below about 800° C.), without any substantially undesirable change in the electrical properties of the perovskite type metal oxide or the ceria based metal oxide.

In the cathode manufactured in the foregoing manner, a second cathode layer and/or a current collector layer may be further formed, wherein the second cathode layer and/or the current collector layer may include another cathode material, such as a commercially available cathode material used in the art.

According to a further aspect, a solid oxide fuel cell (“SOFC”) having a cathode including the cathode material for a fuel cell, an anode disposed opposite to the cathode, and a solid oxide electrolyte interposed between the cathode and the anode is provided.

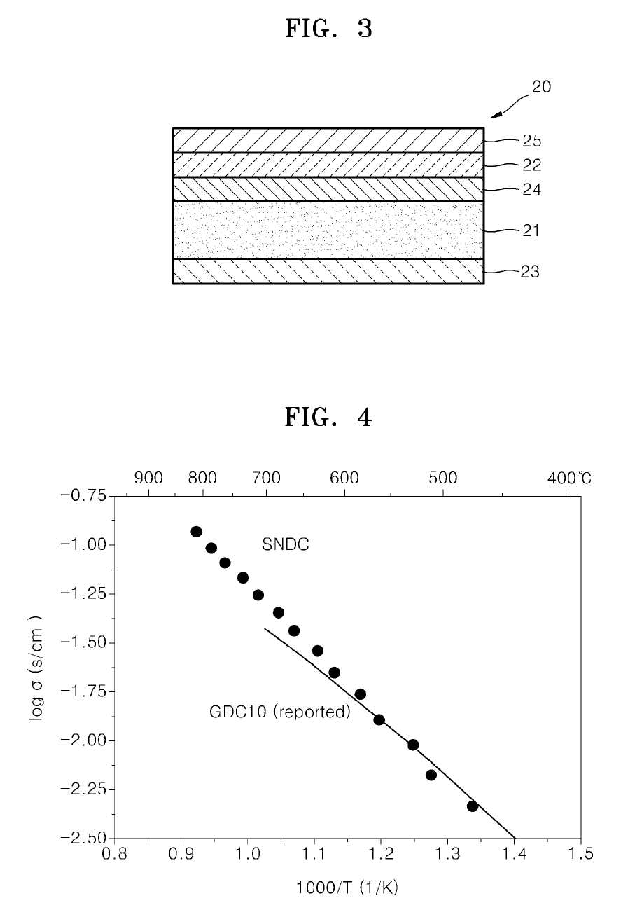

FIG. 3 schematically illustrates a structure of the SOFC according to an embodiment. Referring to FIG. 3, in the SOFC 20, the cathode 22, and the anode 23 are arranged on opposite sides of the solid oxide electrolyte 21.

The solid oxide electrolyte 21 desirably has a sufficient density so that a gas and a fuel cannot directly contact therein, and has high oxygen ion conductivity and low electronic conductivity. The electrolyte 21 also desirably maintains the same physical properties over a large range of oxygen partial pressure, because there is a relatively large change in the oxygen partial pressure between the cathode 22 and the anode 23, which are on opposite sides of the electrolyte 21.

A material for forming the solid oxide electrolyte 21 is not particularly limited, and may be any solid oxide electrolyte material used in the art. For example, the solid oxide electrolyte 21 can be at least one selected from a stabilized zirconia such as yttria stabilized zirconia (“YSZ”) or scandia stabilized zirconia (“ScSZ”), a ceria based material having a rare earth element as an additive, such as samarium doped ceria (“SDC”) or gadolinium doped ceria (“GDC”), and a lanthanum strontium gallate magnesite (“LSGM”) ((La, Sr)(Ga, Mg)O₃).

The thickness of the solid oxide electrolyte 21 may range from about 10 nanometers (nm) to about 100 micrometers (μm), specifically 20 nm to 50 μm, more specifically 40 nm to 25 μm. For example, the solid oxide electrolyte 21 may have a thickness of about 100 nm to about 50 μm.

The anode 23 (e.g., the fuel electrode) serves to electrochemically oxidize a fuel and deliver charges (e.g., electrons). An anode catalyst for oxidizing the fuel desirably has suitable physical and chemical properties. For example, the anode catalyst is desirably chemically stable when in contact with the materials for forming the solid oxide electrolyte 21, the solid oxide electrolyte 21, and desirably has a coefficient of thermal expansion which is similar to that of the solid oxide electrolyte 21. The anode 23 may include a cermet, and may comprise a material used for forming the solid oxide electrolyte 21, e.g., a nickel oxide. For example, if YSZ is used for the solid oxide electrolyte 21, a Ni/YSZ ceramic-metallic hybrid composite may be used for the anode 23. In addition, a Ru/YSZ cermet, or a pure metal, such as a metal selected from, but not limited to, Ni, Co, ruthenium (Ru), and Pt, may be used for the anode 23. The anode 23 may additionally include activated carbon if desired. The anode, e.g., the anode 23, may be porous and have a porosity selected so that a fuel gas can easily diffuse into the anode 23.

A thickness of the anode 23 may range from about 1 μm to about 1000 μm in thickness. For example, the thickness of the anode 23 may range from about 5 μm to about 100 μm.

The cathode 22 (e.g., the gas electrode), in which an oxygen gas is reduced to oxygen ions, maintains a constant oxygen partial pressure due to a continuous flow of the oxygen gas to the cathode 22. As is further described above, the cathode 22 comprises the cathode material including the perovskite type metal oxide and the co-doped ceria based metal oxide. The cathode material has already been described above, and thus further description thereof is omitted here.

The thickness of the cathode 22 may range from about 1 μm to about 100 μm. For example, the thickness of the cathode 22 may range from about 5 μm to about 50 μm, specifically 10 μm to 40 μm.

The cathode 22 may be porous and have a porosity selected so that oxygen gas can easily diffuse into the cathode 22.

According to an embodiment, an additional functional layer, for example, a reaction preventing layer 24, may be included between the cathode 22 and the solid oxide electrolyte 21. The reaction preventing layer 24 is effective to substantially or effectively prevent or suppress the formation of a non-conductive layer between the cathode 22 and the solid oxide electrolyte 21. While not wanting to be bound by theory, it is understood that the reaction preventing layer prevents or suppresses a reaction between the cathode 22 and the solid oxide electrolyte 21. The reaction preventing layer 24 may include at least one selected from GDC, SDC, and yttria doped ceria (“YDC”), for example. A thickness of the reaction preventing layer 24 may range from about 1 μm to about 50 μm. For example, a thickness of the reaction preventing layer 24 may range from about 2 μm to about 25 μm, specifically about 2 μm to about 10 μm.

According to an embodiment, the SOFC 20 may further include a current collector layer 25 containing an electron conductor and disposed (e.g., formed) on at least one side of the cathode 22. For example, the current collector layer 25 may be disposed on an outer side of the cathode 22, e.g. a side of the cathode opposite the electrolyte. The current collector layer 25 may collect charges.

The current collector layer 25 may include at least one selected from a lanthanum cobalt oxide (LaCoO₃), a lanthanum strontium cobalt oxide (“LSC”), a lanthanum strontium cobalt ferrous oxide (e.g., La_{0.55}Sr_{0.4}Co_{0.2}Fe_{0.8}O₃, LSCF), a lanthanum strontium chrome manganese oxide (“LSCM”), a lanthanum strontium manganese oxide (“LSM”), and a lanthanum strontium ferrous oxide (“LSF”), for example. The current collector may be a single layered structure or a multi-layered structure including two or more layers, wherein each layer is independently selected from lanthanum cobalt oxide (LaCoO₃), LSC, LSCF, lanthanum strontium chrome manganese oxide, LSM, and LSF.

The SOFC may be manufactured using commercially available methods which are known to one of skill in the art or can be determined by one of skill in the art without undue experimentation, and thus a further description of how to manufacture the SOFC is omitted here. The SOFC may be applied in various configurations, such as a tubular stack, a flat tubular stack, or a planar type stack.

Next, this disclosure is further illustrated with reference to exemplary embodiments. The scope of the present disclosure shall not be limited thereto.

### PREPARATION EXAMPLE 1

### Manufacture of the Cathode (1)

To manufacture Ce_{0.8}Sm_{0.15}Nd_{0.05}O₂, which is an ionically conductive powder and is a Sm, Nd-doped ceria (“SNDC”), first, 19.920 grams (g) of Ce(NO₃)₃.6H₂O, 3.823 g of Sm(NO₃)₃.6H₂O, 1.257 g of Nd(NO₃)₃.6H₂O, and 6.816 g of urea were put into 100 milliliters (ml) of distilled water, and agitated with a bar magnet until they were completely dissolved. Using a hot plate, the resulting solution was heated at about 150° C. for twelve hours to obtain dry powder. By heating the obtained dry powder at about 800° C. for two hours, Ce_{0.80}Sm_{0.15}Nd_{0.05}O₂ (“SNDC”) having a fluorite structure was obtained.

The cathode material was obtained by putting 2.5 g of La_{0.6}Sr_{0.4}Co_{0.2}Fe_{0.8}O₃ powder (FCM, hereinafter referred to LSCF) and 2.5 g of SNDC as obtained above into a tungsten vial, adding 10 ml of ethanol into the tungsten vial, mixing them with a high energy miller (Mixer/Mill 8000D, Spex), and then drying the mixture in an oven.

### PREPARATION EXAMPLE 2

### Manufacture of the Cathode (2)

A site defective lanthanum strontium cobalt ferrous oxide having the formula La_{0.55}Sr_{0.4}Co_{0.2}Fe_{0.8}O₃ powder was manufactured using a urea method. Specifically, 8.457 g of La(NO₃)₃.6H₂O, 3.004 g of Sr(NO₃)₂, 2.066 g of Co(NO₃)₃.9H₂O, 11.472 g of Fe(NO₃)₃.9H₂O, and 7.288 g of urea (CH₄N₂O) were put into 100 ml of distilled water, and agitated with a bar magnet until they were completely dissolved. Using a hot plate, the resulting solution was heated at about 150° C. for twelve hours to obtain a dry powder. By heating the obtained dry powder at about 1000° C. for two hours, La_{0.55}Sr_{0.4}Co_{0.2}Fe_{0.8}O₃ (“L_{0.55}SCF”) powder having a perovskite structure was obtained.

The cathode material was obtained by putting 2.5 g of L_{0.55}SCF powder as obtained above and 2.5 g of SNDC powder as obtained in Preparation Example 1 into a tungsten vial, adding 10 ml of ethanol into the tungsten vial, mixing them with a high energy miller (Mixer/Mill 8000D, Spex), and then drying the mixture in an oven.

### PREPARATION EXAMPLE 3

### Manufacture of the Cathode (3)

The same process as in Preparation Example 2 was used to obtain the cathode material, except that La_{0.55}Sr_{0.35}Co_{0.2}Fe_{0.8}O₃ (“L_{0.55}S_{0.35}CF”) as a lanthanide strontium cobalt ferrous oxide was manufactured using a solution obtained by adding 8.586 g of La(NO₃)₃.6H₂O, 2.669 g of Sr(NO₃)₂, 2.0975 g of Co(NO₃)₃.9H₂O, 11.674 g of Fe(NO₃)₃.9H₂O, and 6.949 g of urea (CH₄N₂O) into 100 ml of distilled water and then dissolving the mixture.

### PREPARATION EXAMPLE 4

### Manufacture of the Cathode (4)

The cathode material was obtained by measuring 72 weight percent (wt %), 8 wt %, and 20 wt % of L_{0.55}S_{0.35}CF having the perovskite structure as obtained above, Co₃O₄ commercially available powder (Aldrich, m.p. 895° C.) having the spinel structure, and SNDC having the fluorite structure, respectively mixing them by ball milling in an ethanol medium using a zirconia ball, and then drying the resulting mixture in an oven. The contents are equal to 0.8{(L_{0.55}S_{0.35}CF)0.9+(Co₃O₄)0.1}+0.2SNDC.

### COMPARATIVE EXAMPLE 1

### Ion Conductor Control Group

As a control group to compare the ionic conductivity of the ion conductor SNDC used for the cathode material in Preparation Examples 1 and 2, 10 mole percent (mol %) gadolinium doped ceria (“GDC”), specifically Ce_{0.9}Gd_{0.1}O₂ (“GDC10”), as a representative electrolyte composite, as reported in “Z. Tianshu, et. al., Solid State Ionics (2002) 567”, was used.

### EVALUATION EXAMPLE 1

### Measurement of Ionic Conductivity of an Ion Conductor

To measure the ionic conductivity of the ion conductor SNDC (i.e., Ce_{0.8}Sm_{0.15}Nd_{0.05}O₂) used for the cathode materials in Preparation Examples 1-3, a 4-probe DC method was used. To manufacture a bulk sample, SNDC powder manufactured as described above was deposited into a metal mold, pressed by applying 200 megaPascals (MPa) through cold isostatic pressing (“CIP”), and then sintered at about 1550° C. As a result, a coin-shaped bulk sample having a thickness of about 0.35 centimeter (cm) and a diameter of about 2 cm was obtained. To measure electrical resistance, the bulk sample was cut into a form of a bar having the dimensions 0.7 cm in length, 0.2 cm in thickness, and 0.33 cm in height, and then the electrical resistance measured in air with a current-voltage source meter (2400, Keithley) at various temperatures.

FIG. 4 is a comparison of the measured ionic conductivity of the SNDC Ce_{0.8}Sm_{0.15}Nd_{0.05}O₂, the SNDC of Preparation Examples 1-3, with that of the GDC Ce_{0.9}Gd_{0.1}O₂ (GDC10) of Comparative Example 1.

As shown in FIG. 4, the ion conductor Ce_{0.8}Sm_{0.15}Nd_{0.05}O₂(“SNDC”) used in the cathode materials in Preparation Examples 1-3 has a higher ionic conductivity than that of the singly doped Gd-doped CeO₂ GDC10 of Comparative Example 1. From this result, it is determined that the ion conductor of Preparation Examples 1-3 when mixed with an LSCF cathode material can be used in a hybrid conductor layer, to provide improved ionic conductivity and thus significantly improved cathode performance.

### EXAMPLES 1-3

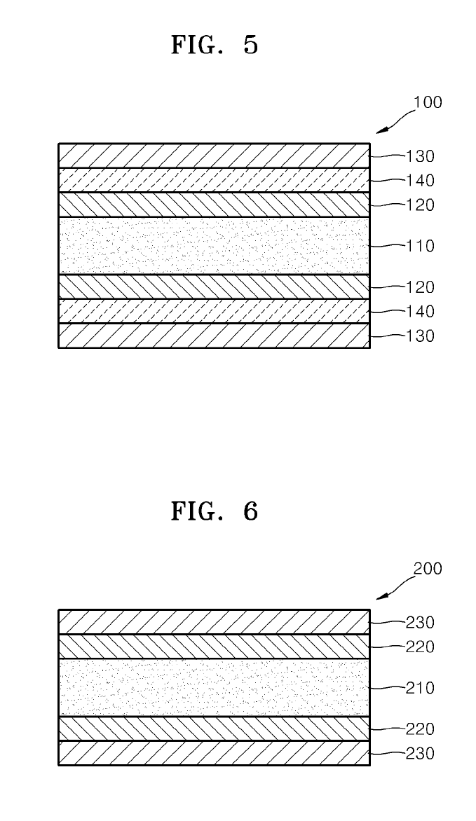

To measure cathode resistance, as shown in FIG. 5, a symmetric cell 100 was manufactured by coating a pair of reaction preventing layers 120, a pair of cathode layers 140, and a pair of current collector layers 130 in sequence, one of each pair being located on one side of an electrolyte layer 110, while the other of each pair was located on the other side of the electrolyte layer 110.

In manufacturing the symmetric cell 100, the electrolyte layer 110 was manufactured from the scandia stabilized zirconia powder (“ScSZ”) Zr_{0.8}Sc_{0.2}O₂ (FCM, USA) by putting the powder into a metal mold, pressing the powder into a pellet, and then sintering the pellet at about 1550° C. for eight hours to provide a coin-shaped electrolyte material having a thickness of 1 millimeter (mm), to provide the electrolyte layer 110. The reaction preventing layers 120 having a thickness of 10 μm were formed by mixing the gadolinium doped ceria (“GDC”) Ce_{0.9}Gd_{0.1}O₂ (FCM, USA), a commercial ink vehicle (FCM Ink vehicle, (VEH)) solvent, and a mortar to make a slurry, screen printing the slurry on opposite sides of the electrolyte layer 110, and heating the resulting structure at about 1200° C. for two hours. Next, the cathode slurry layers 140 of Examples 1-3, respectively, were each formed by making a slurry with 1 g of the cathode materials manufactured in Preparation Examples 1-3, respectively, and 1 ml of the commercially available FCM Ink vehicle (VEH), and screen printing the slurry to a thickness of 10 μm on the reaction preventing layers 120. After that, as a material for the current collector layers 130, La_{0.6}Sr_{0.4}Co_{0.2}Fe_{0.8}O₃(LSCF, FCM) was used to make a slurry with a solvent of the commercially available FCM Inc. vehicle (VEH), and the resulting slurry was screen printed to a thickness of 20 μm on each of the cathode slurry. Heating the screen printed slurry with the hybrid cathode slurry layer at about 1000° C. for two hours completed the manufacturing of the symmetric cell 100.

### COMPARATIVE EXAMPLE 2

To measure cathode resistance, a symmetric cell 200 was manufactured by coating a pair of reaction preventing layers 220 and a pair of cathode layers 230 in sequence, one of each pair being located on one side of an electrolyte layer 210, while the other of each pair was located on the other side of the electrolyte layer 210, as illustrated in FIG. 6. In manufacturing the symmetric cell 200, the electrolyte layer 210, the reaction prevention layers 220, and the cathode layers 230 were formed in the same way as the electrolyte layer 110, the reaction prevention layers 120, and the current collector layers 130 were formed in Example 1. That is, LSCF was used to form the cathode layer 230.

### COMPARATIVE EXAMPLE 3

A symmetric cell as shown in FIG. 5 was manufactured in the same process as in Example 1, except that the LSCF (La_{0.6}Sr_{0.4}Co_{0.2}Fe_{0.8}O₃. FCM, USA) and the GDC (Ce_{0.9}Gd_{0.1}O₂) (FCM, USA) were used in a 1:1 weight ratio as the cathode material when forming the cathode layers 140.

### EVALUATION EXAMPLE 2

### XRD Pattern Measurement

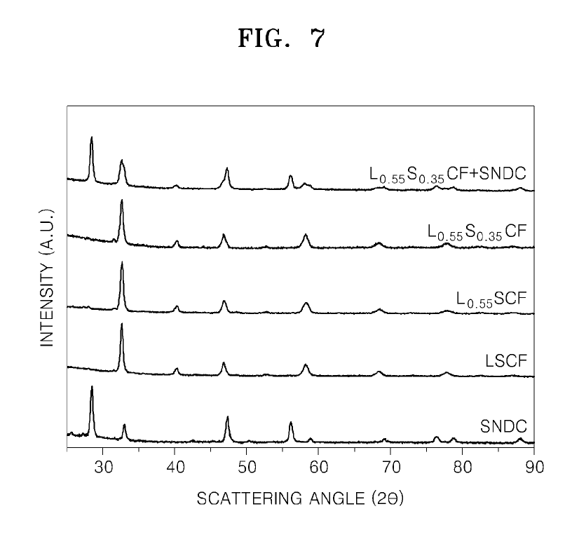

Results of measuring X-ray diffraction patterns on the cathode layers 140 (L_{0.55}S_{0.35}CF+SNDC) of the symmetric cell 100 manufactured in Example 3, using CuKα X-rays, are shown in FIG. 7. In FIG. 7, respective X-ray diffraction patterns of the LSCF compounds (LSCF, L_{0.55}SCF, L_{0.55}S_{0.35}CF) and the SNDC are shown for comparison.

As shown in FIG. 7, it can be seen that each of the LSCF compounds and the SNDC were single phase perovskite crystal structures and fluorite crystal structures, respectively. Furthermore, even after heating the cathode materials used for the cathode layers 140 in Example 3, it can be seen that the respective phases of the perovskite and fluorite crystal structures remained intact without an appearance of other phases, which indicates that the obtained cathode materials are in a physically mixed state.

### EVALUATION EXAMPLE 3

### SEM Measurement

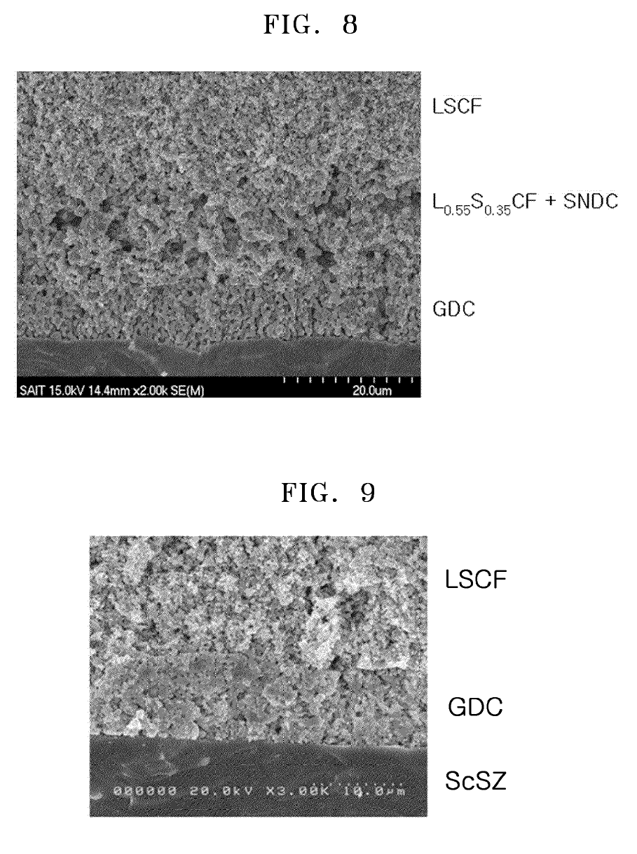

Images of magnified cross sections of the symmetric cell 100 manufactured in Example 3 and of the symmetric cell 200 manufactured in Comparative Example 2, obtained using a scanning electron microscope, are shown in FIGS. 8 and 9, respectively.

Referring to FIGS. 8 and 9, it can be seen that in both of Example 3 and Comparative Example 2, the zirconia solid electrolytes, the ceria reaction prevention layers, and the cathode layers were densely formed.

### EVALUATION EXAMPLE 4

### Impedance Measurement

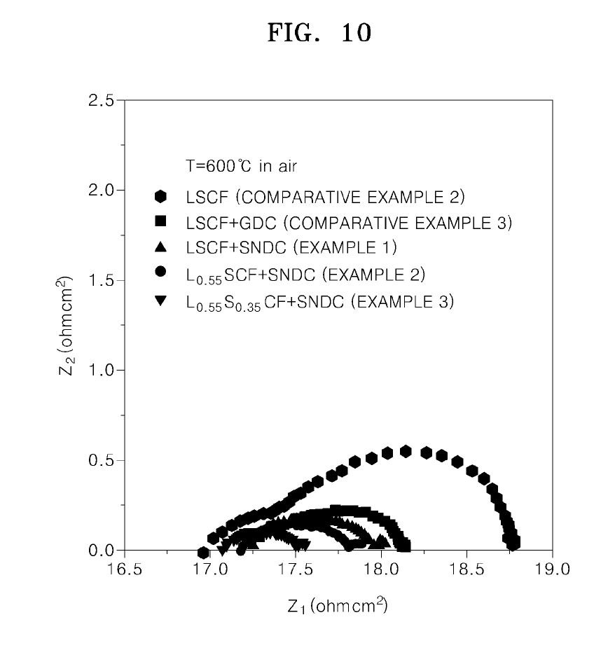

Impedances of the symmetric cells manufactured in Examples 1-3 and Comparative Examples 2 and 3 were measured in air and the results are shown in FIG. 10 and Table 1. As an impedance measuring instrument, a Materials Mates 7260 of Materials Mates, Inc. was used. In addition, operating temperatures for the symmetric cells were maintained at about 600° C.

TABLE 1

| | Cathode Material | R_{ca} | Rₚ |
|---|---|---|---|
| Comparative Example 2 | LSCF | 1.82 | 0.91 |
| Comparative Example 3 | LSCF + GDC | 0.96 | 0.48 |
| Example 1 | LSCF + SNDC | 0.90 | 0.45 |
| Example 2 | L_{0.55}SCF + SNDC | 0.80 | 0.40 |
| Example 3 | L_{0.55}S_{0.35}CF + SNDC | 0.50 | 0.25 |

In FIG. 10, the sizes of the semi-circles correspond to a magnitude of the cathode resistance R_{ca} and resistivity Rₚ is R_{ca}/2. It can be seen from FIG. 10 that cathode resistance of the symmetric cell using the cathode material where SNDC was added to LSCF in Example 1 was smaller than that of the symmetric cell of Comparative Example 2, which used only LSCF, or the cell of Comparative Example 3, which used a cathode material of LSCF and GDC. Furthermore, it can be seen that cathode resistance of the symmetric cells using the cathode material where the non-stoichiometric L_{0.55}SCF and SNDC were mixed and the cathode material where L_{0.55}S_{0.35}CF and SNDC were mixed in Examples 2 and 3, respectively, were even smaller. From these results, it can be understood that adding a material that has high ionic conductivity, such as SDNC, to a lanthanum ferrite cathode material, or removing A-site elements from LSCF, which is known to have electronic conductivity, to also provide ionic conductivity, can reduce a cathode resistance of the lanthanide ferrite cathode material.

### EVALUATION EXAMPLE 5

### Cathode Resistivity Measurement

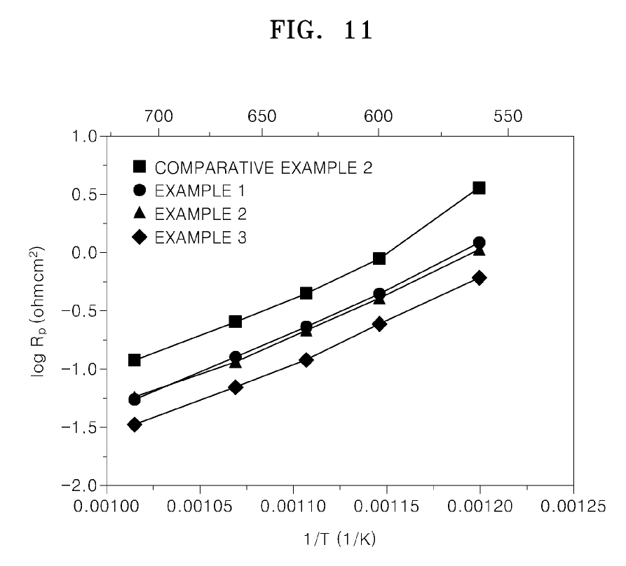

Impedance of each of the symmetric cells manufactured in Examples 1-3 and Comparative Example 2 was measured in air while varying an operating temperature of the symmetric cells. The same instrument as used in Evaluation Example 4 for measuring impedances was used here. Resistivity Rₚ=R_{ca}/2 (½ was set because each cell is symmetric) calculated from a total resistance of each respective symmetric cell, R_{ca}, at different operating temperatures, is shown in FIG. 11 as a function of temperature.

Referring to FIG. 11, it can be seen that cathode resistivities of the symmetric cells using the cathode material where the LSCF compound and SNDC were mixed in Examples 1-3 were smaller than that of the symmetric cell in Comparative Example 2. In other words, the ionic conductivity of the cathode material having a combination of the LSCF compound and SNDC was enhanced and had superior cathode performance over a LSCF cathode material.

### EXAMPLE 4

In order to determine the effect on electrode resistivity when Co₃O₄ having the spinel structure and SNDC having the fluorite structure is added to L_{0.55}S_{0.35}CF having the perovskite structure, a symmetric cell having a pair of cathode layers coated on two/opposite sides of an electrolyte layer was manufactured. The electrolyte layer was manufactured from scandia stabilized zirconia (“ScSZ”, Zr_{0.8}Sc_{0.2}O₂) (FCM, USA) powder by putting the powder into a metal die mold, applying 200 MPa in a cold isostatic press (“CIP”) thereto, and then sintering it at about 1550° C. into a coin-shaped bulk compact 1 mm in thickness. Opposite sides of the bulk compact were coated with GDC powder (commercially available from Fuel Cell Materials, Inc.) via screen printing, and were again screen printed as a slurry in 10 μm thickness manufactured by mixing the L_{0.55}S_{0.35}CF+Co₃O₄+SNDC cathode materials of Preparation Example 4 with a mortar using a common solvent (Ink Vehicle, FCM), thus coating the cathode layer. After that, as a material for the current collector layers, La_{0.6}Sr_{0.4}Co_{0.2}Fe_{0.8}O₃ (FCM, USA) was used to make a slurry with a solvent of the FCM Ink vehicle (VEH, FCM, USA), and the resulting slurry was screen printed to a thickness of 20 μm on a reaction preventing layer. Heating the screen printed slurry at about 900° C. completed the manufacturing of the symmetric cell.

### COMPARATIVE EXAMPLE 4

A symmetric cell was manufactured in the same process as in Example 4, except for using L_{0.55}S_{0.35}CF alone as a cathode material in Example 4.

### EVALUATION EXAMPLE 7

### Impedance Measurement

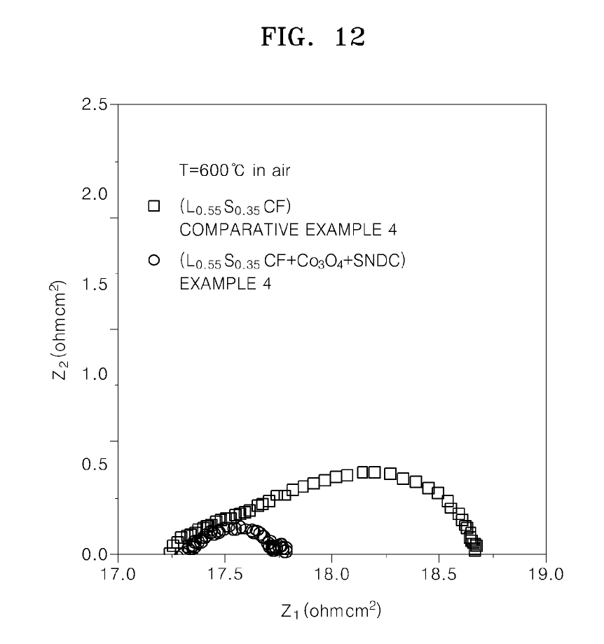

Impedances of the symmetric cells manufactured in Example 4 and Comparative Example 4 were measured in air and shown in FIG. 12.

Similar to FIG. 10, the sizes of the semi-circles in FIG. 12 correspond to magnitudes of the cathode resistances R_{ca}. It can be seen from FIG. 12 that the size of the semi-circle of the symmetric cell using the combination of L_{0.55}S_{0.35}CF+Co₃O₄+SNDC in the cathode material of Example 4 was smaller than that of the cathode material of the symmetric cell using L_{0.55}S_{0.35}CF alone as in Comparative Example 4. FIG. 12 shows that a material having a spinel structure (e.g., Co₃O₄) is an effective additive when used together with the fluorite structured ion conductor SNDC, in terms of cathode performance.

### EVALUATION EXAMPLE 8

### Cathode Resistivity Measurement

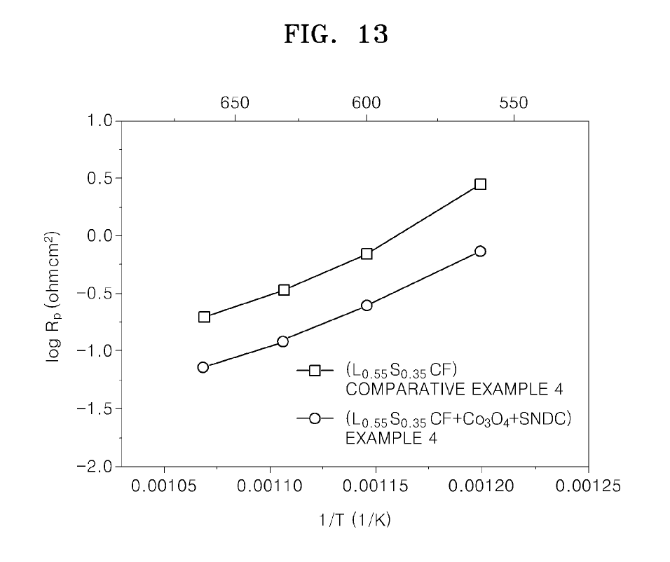

Impedance of each of the symmetric cells manufactured as in Example 4 and Comparative Example 4 was measured in air by varying an operating temperature of the symmetric cells. Arrhenius plots of cathode resistivity of the symmetric cells with respect to their respective operating temperatures are shown in FIG. 13.

It is seen from FIG. 13 that resistivity of the symmetric cell employing the combination L_{0.55}S_{0.35}CF+Co₃O₄+SNDC in the cathode material is smaller than that of the symmetric cell employing only L_{0.55}S_{0.35}.

A cathode material for a fuel cell according to an embodiment helps to increase oxygen ion conductivity and thus decreases the polarization resistance at a cathode of an SOFC, thereby keeping the electrode resistance low at a low temperature, e.g. at 800° C. or below. Accordingly, the SOFC, which may be operated at a lower temperature, e.g., 800° C. or below, may be produced by employing the cathode material.

It should be understood that the exemplary embodiments described herein should be considered in a descriptive sense only and not for purposes of limitation. Descriptions of features or aspects within each embodiment should typically be considered as available for other similar features or aspects in other embodiments.

What is claimed is:

1. A cathode material for a fuel cell, the cathode material comprising:
a first metal oxide having a perovskite crystal structure; and
a second metal oxide comprising cerium and at least two lanthanide elements, the lanthanide elements having an average ionic radius of about 0.90 to about 1.02 Å.

2. The cathode material for a fuel cell of claim 1, wherein the first metal oxide is represented by Formula 1:
A₁₋ₓM¹O_{3±δ} Formula 1
wherein A is at least one element selected from a lanthanide element and an alkaline earth metal element;
M¹ is at least one transition metal element;
0≦x≦0.2; and
δ is selected so that the first metal oxide is neutral.

3. The cathode material for a fuel cell of claim 2, wherein A is at least one element selected from La, Ba, Sr, Sm, Gd, and Ca, and M¹ is at least one element selected from Mn, Fe, Co, Ni, Cu, Ti, Nb, Cr, and Sc.

4. The cathode material for a fuel cell of claim 2, wherein the first metal oxide comprises a defect on an A site of a lattice structure thereof.

5. The cathode material for a fuel cell of claim 2, wherein the first metal oxide is represented by Formula 2:
A′_{1-y-z}A″_{y-z′}M¹O_{3±δ} Formula 2
wherein A′ is at least one element selected from Ba, La, and Sm,
A″ is at least one element selected from Sr, Ca, and Ba and is different from A′;
M¹ is at least one element selected from Mn, Fe, Co, Ni, Cu, Ti, Nb, Cr, and Sc;
0≦y<1, 0≦z≦0.2, 0≦z′≦0.2 wherein0≦y+z<1, y>z′, and 0≦z+z′≦0.2; and
δ is selected so that the first metal oxide is electrically neutral.

6. The cathode material for a fuel cell of claim 5, wherein the first metal oxide comprises a defect on at least one selected from an A′ site and an A″ site of a lattice structure thereof.

7. The cathode material for a fuel cell of claim 1, wherein the second metal oxide has a fluorite crystal structure.

8. The cathode material for a fuel cell of claim 1, wherein an average ionic radius of the lanthanide elements of the second metal oxide is about 0.96 to about 0.98 Å.

9. The cathode material for a fuel cell of claim 1, wherein the at least two lanthanide elements of the second metal oxide are selected from Sm, Pr, Nd, Pm, Eu, Gd, Tb, Dy, and an alloy thereof.

10. The cathode material for a fuel cell of claim 1, wherein the second metal oxide is represented by Formula 3:
Ce_{1-a-b}SmₐM²_{b}O₂ Formula 3
wherein M² is at least one selected from Pr, Nd, Pm, Eu, Gd, Tb, Dy, and an alloy thereof; and
0<a≦0.20, 0<b≦0.20, and 0<a+b≦0.3.

11. The cathode material for a fuel cell of claim 10, wherein b of Formula 3 is a/2 or less.

12. The cathode material for a fuel cell of claim 1, wherein a weight ratio of the first metal oxide to the second metal oxide is about 1:9 to about 9:1.

13. The cathode material for a fuel cell of claim 12, wherein the weight ratio of the first metal oxide to the second metal oxide is about 3:7 to about 7:3.

14. The cathode material for a fuel cell of claim 1, further comprising
a third metal oxide having a spinel crystal structure.

15. The cathode material for a fuel cell of claim 14, wherein the third metal oxide is represented by Formula 4:
M₃³O₄ Formula 4
wherein M³ is at least one selected from Co, Fe, Mn, V, Ti, Cr, and an alloy thereof.

16. The cathode material for a fuel cell of claim 15, wherein the third metal oxide comprises at least one selected from Co₃O₄, Fe₃O₄, and Mn₃O₄.

17. The cathode material for a fuel cell of claim 14, wherein a melting point of the third metal oxide ranges from about 800° C. to about 1800° C.

18. The cathode material for a fuel cell of claim 14, wherein a weight ratio of the first metal oxide to the third metal oxide is about 60:40 to 99:1.

19. A cathode comprising the cathode material for a fuel cell according to claim 1.

20. A fuel cell comprising:
a cathode comprising the cathode material for a fuel cell according to claim 1;
an anode disposed opposite to the cathode; and
a solid oxide electrolyte interposed between the cathode and the anode.

21. The fuel cell of claim 20, further comprising,
a reaction preventing layer effective to prevent or suppress a reaction between the cathode and the solid oxide electrolyte.

22. The fuel cell of claim 21, wherein the reaction preventing layer comprises at least one selected from gadolinium doped ceria, samarium doped ceria, and yttrium doped ceria.

23. The fuel cell of claim 20, further comprising,
a current collector layer disposed on a side of the cathode opposite the solid oxide electrolyte.

24. The fuel cell of claim 23, wherein the current collector is at least one selected from a lanthanum cobalt oxide, a lanthanum strontium cobalt oxide, a lanthanum strontium cobalt ferrite, a lanthanum strontium chrome manganese oxide, a lanthanum strontium manganese oxide, and a lanthanum strontium ferrite.

25. A method of manufacturing a cathode material, the method comprising:
contacting a first metal oxide having a perovskite crystal structure, a second metal oxide comprising cerium and at least two lanthanide elements, and a solvent to form a slurry; and
heating the slurry to form the cathode material.

26. The method of claim 25, wherein the contacting includes mixing in a ball mill.

27. The method of claim 25, wherein the cathode material comprises a physical mixture of the first metal oxide and the second metal oxide.

28. The method of claim 25, wherein the contacting further comprises contacting with a third metal oxide having a spinel crystal structure.

29. The method of claim 25, further comprising disposing the slurry on a substrate; and wherein the heating comprises heating the slurry and the substrate to form a cathode.

30. The method of claim 29, wherein the substrate is a solid oxide electrolyte.
